(19) United States
(12) Patent Application Publication
(10) Pub. No.: US 2006/0200464 A1
(43) Pub. Date: Sep. 7, 2006

(54) Method and system for generating a document summary

(75) Inventors: Michal Gideoni, Seattle, WA (US); David J. Lee, Redmond, WA (US); Dmitriy Meyerzon, Bellevue, WA (US); Mihai Petriuc, Redmond, WA (US); Kyle G. Peltonen, Issaquah, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/072,734

(22) Filed: Mar. 3, 2005

(51) Int. Cl. G06F 17/30; G06F 7/00

(52) U.S. Cl. 707/6

(57) ABSTRACT

A text document is segmented into word and sentence information when the document is first presented and indexed. A memory stream is generated for the document. The memory stream includes document title information, word offsets, sentence offsets, the alternate list, and the contents of the document. The memory stream is used to determine which sentences in the document include query terms. The sentences that include query terms are ranked according to a ranking algorithm. The ranking algorithm determines which sentences include the highest number of query terms and the number of occurrences of the query terms in each sentence. A predetermined number of sentences that together contain as many query terms as possible are selected such that the sentences that are most representative of the document with respect to the query are included in the summary. The summary is generated at query time by concatenating the selected sentences with the query terms highlighted.

### BACKGROUND

Search engines allow web users to locate specific information on the Internet. A user submits a query using query terms that describe the sought information. Web documents are indexed (i.e., filtered and segmented into words) when the user submits the query. The output is stored in memory and forwarded to a query engine to find query term matches. Offsets for the words are retained to match the query results to the filter output. The query results are then displayed on an output page. Segmenting the document into words at query time extends the total execution time of the query.

### SUMMARY

The present disclosure is directed to a method and system for generating a document summary. A word breaker segments a text document into separate chunks of data when the document is first presented and indexed. The word breaker collects word and sentence information from the document. The word information includes the word offsets and the length of the words in the document. The sentence information includes the beginning and end offsets of each sentence in the document. The word breaker may encounter a word in the document that has an alternate form or is derived from a root form. The word breaker stores both forms of the word in an alternate list and associates them with each other such that either form of the word may be matched to a query term.

A summarization plug-in processes the segmented document by locating the words in the document, determining the offset and length of each word, and determining the start and end of each sentence. The summarization plug-in serializes the segmented document information to generate a memory stream of bytes. The memory stream includes document title information, word offsets, sentence offsets, the alternate list, and the document contents. The summarization plug-in compresses the memory stream and stores the compressed memory stream in a data store at index time.

A query is submitted that yields a number of documents. A summarizer generates a summary for each document yielded by the query result using the memory stream associated with the document. The offset information and the document contents in the memory stream are used to match the query terms. The sentences that include query terms are ranked according to a ranking algorithm. The ranking algorithm determines which sentences include the highest number of query terms and the highest number of occurrences of the query terms in each sentence. A predetermined number of sentences that best represent the document with respect to the query are selected for inclusion in the summary. The sentences that are selected together contain as many query terms as possible. The summary is generated by concatenating the selected sentences with the query terms highlighted.

In accordance with one aspect of the invention, a document is segmented into document information when the document is indexed. A memory stream is generated using the document information. Words in the memory stream are compared to query terms. The sentences that include a word that matches a query term are ranked. The sentences are ranked according to the number of words in each sentence that match a query term and the number of occurrences of each query term. A summary is generated with a predetermined number of the sentences that together include as many query term matches as possible.

Other aspects of the invention include system and computer-readable media for performing these methods. The above summary of the present disclosure is not intended to describe every implementation of the present disclosure. The figures and the detailed description that follow more particularly exemplify these implementations.

### BRIEF DESCRIPTION OF THE DRAWINGS

FIG. 1 illustrates a computing device that may be used according to an example embodiment of the present invention.

FIG. 2 illustrates a block diagram illustrating a system for generating a document summary, in accordance with at least one feature of the present invention.

FIG. 3 illustrates an exemplary memory stream for generating a document summary, in accordance with at least one feature of the present invention.

FIG. 4 illustrates an operational flow diagram illustrating a process for generating a memory stream of bytes that is used to generate a document summary, in accordance with at least one feature of the present invention.

FIG. 5 illustrates an operational flow diagram of a process for generating a document summary, in accordance with at least one feature of the present invention.

### DETAILED DESCRIPTION

The present disclosure is directed to a method and system for generating a document summary. A text document is segmented into word and sentence information when the document is first presented and indexed. A memory stream is generated for the document. The memory stream includes document title information, word offsets, sentence offsets, an alternate list, and the document contents. The memory stream is used to determine which sentences in the document include query terms. The sentences that include query terms are ranked according to a ranking algorithm. The ranking algorithm determines which sentences include the highest number of query terms and the highest number of occurrences of each query term. The sentences that together contain as many query terms as possible are selected such that the sentences that are most representative of the document with respect to the query are included in the summary. The summary is generated at query time by concatenating the selected sentences with the query terms highlighted.

Embodiments of the present invention now will be described more fully hereinafter with reference to the accompanying drawings, which form a part hereof, and which show, by way of illustration, specific exemplary embodiments for practicing the invention. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Illustrative Operating Environment

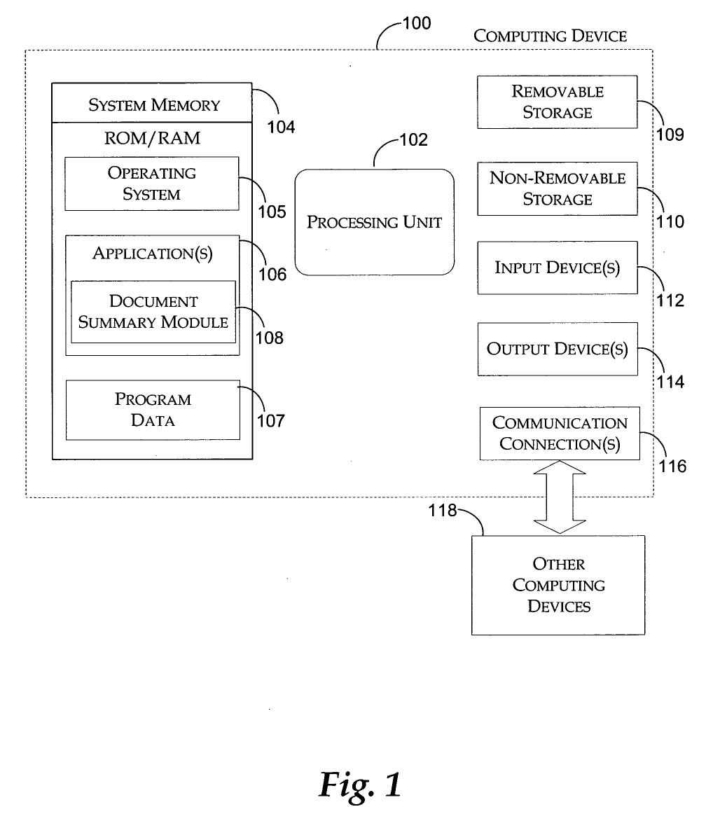

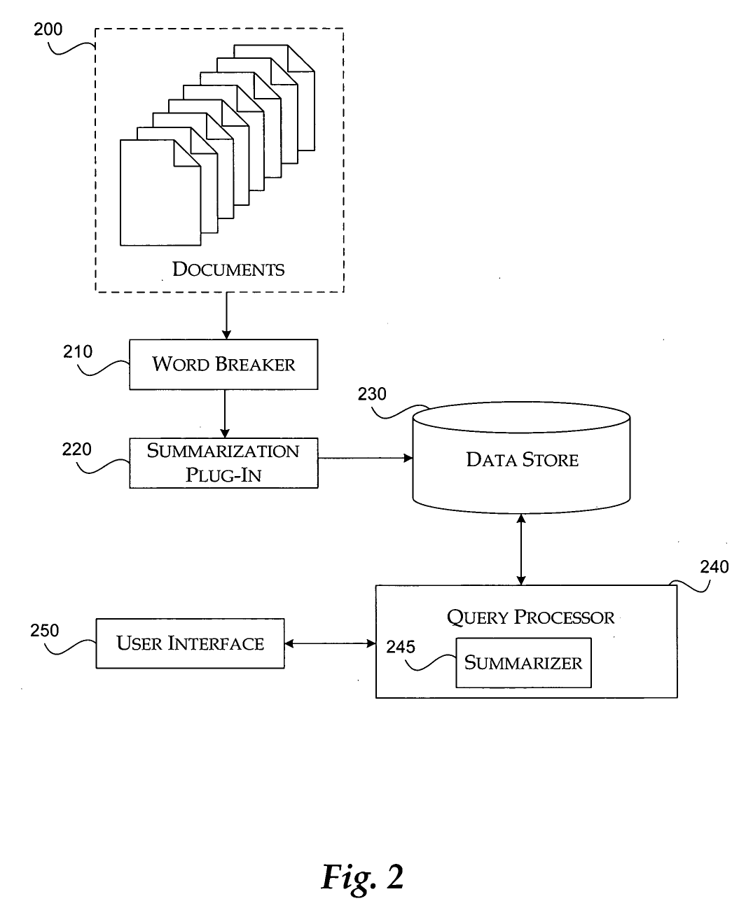

With reference to FIG. 1, one example system for implementing the invention includes a computing device, such as computing device 100. Computing device 100 may be configured as a client, a server, a mobile device, or any other computing device that interacts with data in a network based collaboration system. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. A document summary module 108, which is described in detail below with reference to FIGS. 2-5, is implemented within applications 106.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Networks include local area networks and wide area networks, as well as other large scale networks including, but not limited to, intranets and extranets. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Generating a Document Summary

FIG. 2 illustrates a block diagram of a system for generating a document summary. The summary provides contextual information about the document based on a query. The summary sentences of the document with the query terms highlighted such that the query terms are visually distinct from other terms in the summary. The summary allows a user to understand why the document was retrieved as a query result.

The system includes documents 200, word breaker 210, summarization plug-in 220, data store 230, query processor 240, and user interface 250. Query processor 240 includes summarizer 245. Documents 200 are coupled to word breaker 210. Word breaker 220 is coupled to summarization plug-in 220. Summarization plug-in 220 is coupled to data store 230. Data store 230 is coupled to query processor 240. Query processor is coupled to user interface 250.

Word breaker 210 is an object that segments a text document into separate chunks of data when the document is first presented and indexed. The chunks may be associated with properties to be highlighted in the summary (e.g., a title of the document, a uniform resource locator (URL) associated with the document). Word breaker 210 also collects word and sentence information of the document. The word information includes word offsets and the length of the words in the document. The sentence information includes beginning and end offsets of each sentence in the document. In one embodiment, the offsets refer to byte offset information. Segmenting the document and computing word/sentence offsets when the document is first indexed (i.e., index time) instead of when the query is executed (i.e., query time) reduces the total query time.

While processing a document, word breaker 210 may encounter a word in the document that has an alternate form or is derived from a root form. Word breaker 210 stores both forms of the word and associates them with each other such that either form of the word may be yielded as a search result and highlighted in the summary. For example, word breaker 210 generates two words for “Joe's”: the root form (“Joe”) and the alternate form (“Joe's”). Thus, if the user queried for “Joe”, the word “Joe's” may also highlighted if it appears in the document. Alternatively, if the user queried for “Joe's”, the word “Joe” may be highlighted.

Word breaker 210 calls a PutWord application program interface for each word that is processed in the document, as shown below.

```
SCODE PutWord (
    ULONG cwc,
    WCHAR const pwcInBuf,
    ULONG cwcSrcLen,
    ULONG cwcSrcPos
);
```

where cwc refers to the length of the currently processed word, pwcInBuf refers to the buffer where the word is stored, cwcSrcLen refers to the length of the word in the original document, and cwcSrcPos refers to the position of the word in the buffer.

Word breaker 210 may also call PutAltWord in order to recognize different formats of a word as identical. For example, PutAltWord may be used to recognize different date formats that refer to the same date (e.g., 1/18/05 and Jan. 18, 2005). Thus, a query for 1/18/05 would yield a search result of Jan. 18, 2005 even though the two words are not exact string matches.

The word that is output from PutWord may not be the original word from the document. A word from PutWord or PutAltWord may be determined to be from the original document by checking whether the address of the buffer (i.e., pwcInBuf) lies within the boundaries of the buffer where the original document contents are stored, and by determining that the length of the current word is equal to the length of the original word (i.e., cwcSrcLen=cwc).

Word breaker 210 submits the chunks, word information, and sentence information of the document to summarization plug-in 230 for processing. Summarization plug-in 220 saves a chunk for each property to be highlighted and a set of chunks corresponding to the document contents. In one embodiment, the first 4k bytes of the document are submitted to summarization plug-in 220 for processing. The document is processed by locating the words in the document contents, and determining the offset and length of each word (i.e., for every PutWord and PutAltWord). The beginning and end of each sentence in the document is also determined. Summarization plug-in 220 serializes the chunks, word information and sentence information to generate a memory stream of bytes (i.e., a data structure). The memory stream, described in detail below, includes all of the information needed to generate the summary. Summarization plug-in 220 compresses the memory stream and stores the compressed memory stream in an image field in data store 230 at index time. In one embodiment, data store 230 is an SQL property store, and each document is associated with a row in an SQL table. Compression information (e.g., the size of the memory stream before compression) is also stored for subsequent retrieval when the memory stream is decompressed.

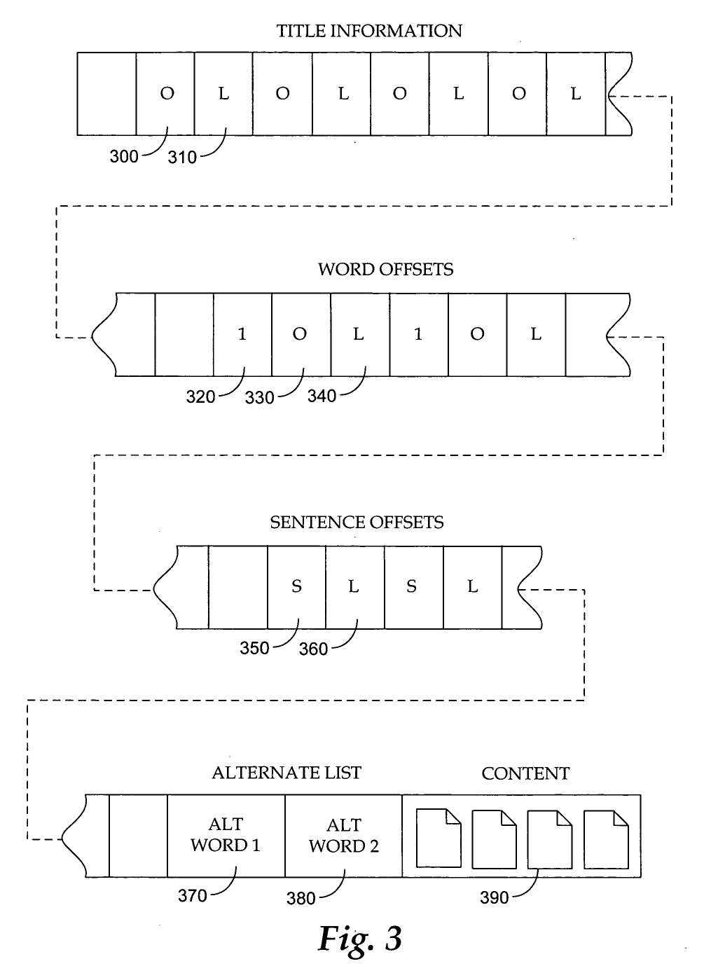

FIG. 3 illustrates an exemplary memory stream for generating a document summary. The memory stream includes title information, word offsets, sentence offsets, an alternate list, and document contents 390. In one embodiment, document contents 390 includes the first 4k bytes of the original raw text of the document. The title information corresponds to the title of the document. The title is one of the properties that is highlighted in the summary. For each word in the title, the memory stream includes offset 300 and word length 310. In one embodiment, alternate forms of words in the title are not recognized. The sentence offsets include start offset 350 and end offset 360 for each sentence in the document.

The alternate list includes words 370, 380 that are alternate forms of original words in the document. The alternate list may also include root forms of a word from the document, i.e., a word from the document is an alternate form of the root form. For example, “Joe” (a root form of “Joe's”) may be stored in the alternate list. At query time, the query term (e.g., “Joe's”) is compared to the words in the original document and the words in the alternate list. Since “Joe” is in the alternate list, a match is found and “Joe's” may be highlighted in the summary.

The memory stream also includes word offsets. For each word in the document contents, the memory stream includes alt bit 320, offset 330 and word length 340. Alt-bit 320 indicates whether there is any more information in the memory stream associated with the word. In one embodiment, alt-bit 320 is set to “0” when there is no further word offset/length information available for the currently processed word (i.e., the next word in the memory stream is not an alternate form of the current word). In one embodiment, alt-bit 320 is set to “1” when additional word offset/length information associated with an alternate form of the currently processed word is available after the current word offset/length information.

Referring back to FIG. 2, the query is generated at user interface 250. User interface 250 submits the query to query processor 240. Query processor 240 segments the query into query terms. The query terms are normalized to enable comparison with words in the memory streams corresponding to documents yielded by the query result. For example, the query terms may be normalized by making all of the characters lower case.

Query processor 240 retrieves the memory streams corresponding to the documents identified by the query result from data store 230. Summarizer 245 generates a summary for each document yielded by the query result at query time using the corresponding memory stream and the query terms. Summarizer 245 also receives a list of document identifiers that identify the documents yielded by the query result. The number of sentences to be included in the summary (symbolized as N) may be selected by a user. Alternatively, N may be a default value. In one embodiment, N is selected to be between 2 and 10. In another embodiment, query processor 240 retrieves N rows of memory streams from data store 230. The original, uncompressed size of the memory stream and any document properties to be highlighted in the summary (e.g., title and URL) are also retrieved. Summarizer 240 then decompresses and iterates the memory stream.

Summarizer 245 extracts the word information, the sentence information, and the document contents from the memory stream. The memory stream is iterated with three pointers: two that iterate the word information, and one that iterates the sentence information. The word/sentence offset information and the document contents are used together to match the query terms and generate the summary. For each sentence, each word is compared to the query terms to determine any matches. In one embodiment, each word that is the same length as a query term and begins with the same character is checked against the query term. If there is a match, the sentence that includes the query term is saved. A match may result when an alternate/root form or a different format of the word is matched to a query term.

Summarizer 245 ranks the sentences that include a word that matches a query term according to the number of words that match query terms present in the sentence and the number of occurrences of each query term in the sentence. As discussed above, alternate/root forms of words and different word formats of words may result in a match when the word is used as a query term. Summarizer 245 ranks the sentences using the following ranking algorithm:
Σ(TF/(k+TF)),

where TF is the frequency of the query term in a sentence and k is a constant. In one embodiment, k is equal to 4.9. The ranking formula not only favors sentences that match more of the query terms, but also favors sentences where query terms appear more often.

A predetermined number (e.g., ten) of the highest ranked sentences is obtained. If the query consists of more than one query term, summarizer 245 selects N sentences from the ten highest ranked sentences that best represent the document for inclusion in the summary. The N sentences are selected such that together the sentences include as many query terms as possible. Ideally, the summary includes all of the query terms. However, the document may not have any one sentence that includes all the query terms. Instead, a few sentences together include all of the query terms. Even if a specific sentence is not ranked in the top N sentences, the sentence may include a query term that is not represented in any of the higher-ranked sentences. This sentence is selected for inclusion in the summary such that the summary includes as many various query terms as possible.

For example, a user may query for the terms “TOY”, “STORY”, and “MOVIE”. The algorithm ranks all of the sentences in the document according to the number of times that the query terms appear in the sentence. The sentences listed below may be ranked the highest. The sentences are listed by rank and also by order of appearance in the document.

1. This movie is a story about a father and a son going on an adventurous vacation . . .

2. The story of this movie is a bit complicated.

3. This movie was the best movie that I have seen in years.

4. Toy Story is a film that . . .

5. This toy was created after the success of the “Monsters” movie.

In one embodiment, all of the sentences listed above are of equal rank because each sentence includes two query terms. In another embodiment, sentence 4 is ranked higher than the other sentences because two of the query terms are adjacent to one another. If two sentences are to be shown in the summary (i.e., N=2), the algorithm selects sentences 1 and 4 because these sentences together include as many query terms as possible. If three sentences are to be included in the summary (i.e., N=3), sentences 1, 4 and 2 are selected. Sentence 2 is selected over sentences 3 and 5 even though they have the same ranking because sentence 2 appears closer to the beginning of the document.

The words in each sentence selected for inclusion in the summary that match the query terms are marked for highlighting. The selected sentences are concatenated into one summary. The summary may also include other properties associated with the document. For example, the title of the document and the URL of the document are included in the summary. The property values are matched to the query terms using the word offset information. In one embodiment, the query terms are highlighted in the title and the URL. In another embodiment, the entire title and URL are highlighted. In one embodiment, the URL is not processed by word breaker 210 at index time. When matching the query terms to the URL, a substring is searched that matches the query terms in the URL string. Summarizer 245 returns the highlighted summary and the highlighted properties to query processor 240. The summary may then be provided to user interface 250 as part of the query result.

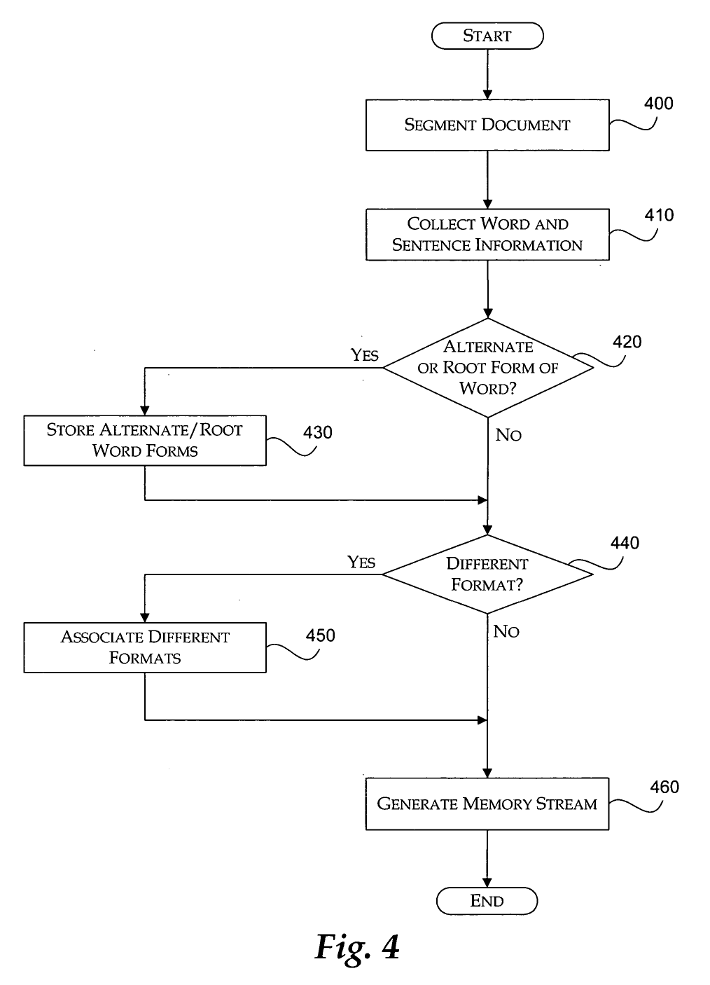

FIG. 4 illustrates an operational flow diagram illustrating a process for generating a memory stream of bytes that is used to generate a document summary. The process begins at a start block where a number of documents are presented and indexed. Each document is processed separately.

A word breaker segments the document into separate data chunks at block 400. In one embodiment, the first 4k bytes of the document are segmented. The data chunks may be associated with properties to be highlighted in the summary. For example, the properties to be highlighted include the title of the document and the URL associated with the document.

Proceeding to block 410, word and sentence information is collected from the document. The word information includes the word offsets and the length of the word. The sentence information includes the beginning and end offsets of each sentence in the document.

Advancing to decision block 420, a determination is made whether an alternate or root form of a word in the document exists. If no alternate or root forms of the word exist, processing continues at block 440. If alternate or root forms of the word exist, processing proceeds to block 430 where alternate/root forms of the word are stored in an alternate list. The alternate/root forms of the word are returned as query results when the query term is an associated alternate/root form of the word.

Transitioning to decision block 440, a determination is made whether different formats of the word are to be recognized as identical. If different formats of the word are not to be recognized as identical, processing continues at block 460. If different formats of the word are to be recognized as identical, processing continues to block 450 where the different formats are associated such that any format of the word is returned as a query result when any format of the word is used as a query term. For example, different date formats may be associated.

Continuing to block 460, a memory stream of bytes is generated and stored in a data base. The memory stream includes all of the information necessary to generate the summary. The memory stream includes document title information, word information, sentence information, the alternate list, and the document contents. In one embodiment, the first 4k bytes of the original raw text of the document are included in the memory stream. The document title information includes the offset and length of each word in the title. The word information includes an alt-bit, an offset and a word length for each word in the document. The alt-bit indicates whether any further information associated with an alternate/root form of the word follows the word in the memory stream. The sentence information includes the start and end offsets for each sentence in the document. The alternate list includes the alternate/root forms of the words in the document. Processing then terminates at an end block.

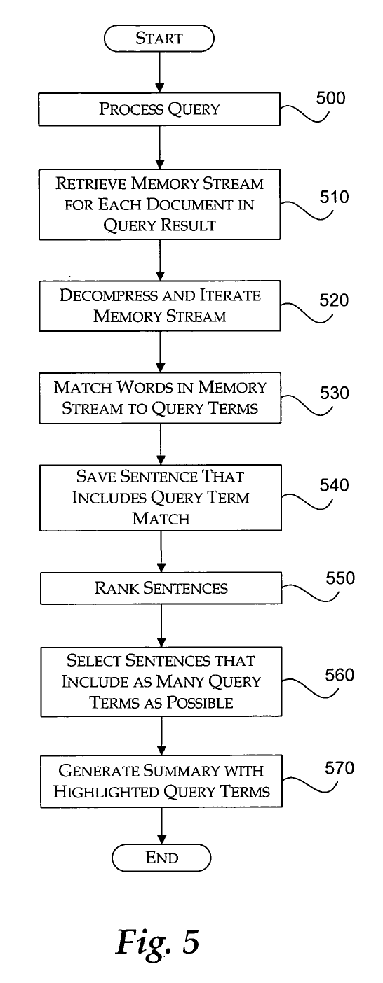

FIG. 5 illustrates an operational flow diagram illustrating a process for generating a document summary. The process begins at a start block where a user generates a query to search web documents for query terms. The query is generated at a user interface and submitted to a query processor.

The query is processed at block 500. The query processor segments the query into the separate query terms. The query terms are normalized to enable comparison with words in the memory stream corresponding to documents yielded by the query result.

Advancing to block 510, the memory stream is retrieved for each document yielded by the query result. The memory stream includes title information, word offsets, sentence offsets, an alternate list, and the document contents. The original, uncompressed size of the memory stream and any document properties to be highlighted in the summary are also retrieved. Moving to block 520, the memory stream is decompressed and iterated. The information in the memory stream is extracted.

Transitioning to block 530, the words in the memory stream are matched to the query terms. The offset information and the document contents are used together to match the query terms. For each sentence, each word is compared to the query terms to determine any matches. Alternate/root forms and different word formats are considered when determining a query term match. In one embodiment, each word that is the same length as a query term and begins with the same character is checked against the query term. Continuing to block 540, each sentence that includes a word that matches a query term is saved.

Proceeding to block 550, the sentences that include a word that matches a query term are ranked according to a ranking algorithm. The ranking algorithm determines which sentences include the highest number of query term matches. The sentences may also be listed in order of appearance in the document.

Advancing to block 560, a predetermined number of sentences that together include as many query terms as possible are selected. The predetermined number may be user selected or a default value.

Moving to block 570, a summary is generated by concatenating the selected sentences with the query term matches highlighted. The summary may also include other document properties such as the URL and the title. In one embodiment, the properties are highlighted. In another embodiment, any query terms in the URL or title are highlighted. Processing then terminates at an end block.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for generating a document summary, comprising:
segmenting the document into document information when the document is indexed;
generating a memory stream using the document information;
comparing words in the memory stream to query terms;
ranking the sentences that include a word that matches a query term, wherein the sentences are ranked according to the number of words in each sentence that match a query term and the number of occurrences of the query terms in each sentence; and
generating the summary with a predetermined number of the sentences that together include as many query term matches as possible.

2. The computer-implemented method of claim 1, further comprising highlighting the query term matches in the summary such that the query term matches are visually distinct from other terms in the summary.

3. The computer-implemented method of claim 1, wherein segmenting the document further comprises collecting word information and sentence information for the document, wherein the word information includes word offsets and the length of words in the document, and wherein the sentence information includes beginning and end offsets of sentences in the document.

4. The computer-implemented method of claim 1, further comprising:
associating a word in the document with an alternate form of the word such that the alternate form of the word matches the word; and
storing the word and the associated alternate form of the word in an alternate list.

5. The computer-implemented method of claim 1, further comprising associating a word with a different format of the word such that the different format of the word matches the word.

6. The computer-implemented method of claim 1, wherein generating a memory stream further comprises serializing the document information in a data structure, wherein the document information comprises at least one of: a title of the document, word offsets for words in the document, sentence offsets for sentences in the document, an alternate list of alternate forms of words in the document, and the contents of the document.

7. The computer-implemented method of claim 1, wherein generating the summary further comprises generating the summary to include properties associated with the document.

8. The computer-implemented method of claim 7, further comprising highlighting the properties associated with the document in the summary.

9. A system for generating a document summary, comprising:
a word breaker that is arranged to segment the document into document information when the document is indexed;
a summarization plug-in that is arranged to generate a memory stream using the document information; and
a summarizer that is arranged to:
compare words in the memory stream to query terms,
rank the sentences that include a word that matches a query term, wherein the sentences are ranked according to the number of words in each sentence that match a query term and the number of occurrences of the query terms in each sentence, and
generate the summary with a predetermined number of the sentences that together include as many query term matches as possible.

10. The system of claim 9, wherein the word breaker is further arranged to:
associate a word in the document with an alternate form of the word such that the alternate form of the word matches the word; and
store the word and the associated alternate form of the word in an alternate list.

11. The system of claim 9, wherein the word breaker is further arranged to associate a word with a different format of the word such that the different format of the word matches the word.

12. The system of claim 9, wherein the word breaker is further arranged to collect word information and sentence information for the document, wherein the word information includes word offsets and the length of words in the document, and wherein the sentence information includes beginning and end offsets of sentences in the document.

13. The system of claim 9, wherein the summarization plug-in is further arranged to:
compress the memory stream; and
store the memory stream in a data store.

14. The system of claim 9, wherein the summarization plug-in is further arranged to serialize the document information in a data structure, wherein the document information comprises at least one of: a title of the document, word offsets for words in the document, sentence offsets for sentences in the document, an alternate list of alternate forms of words in the document, and the contents of the document.

15. The system of claim 9, wherein the summarizer is further arranged to highlight the query term matches in the summary such that the query term matches are visually distinct from other terms in the summary.

16. The system of claim 9, wherein the summarizer is further arranged to:
generate the summary to include properties associated with the document; and
highlight the properties in the summary.

17. The system of claim 9, wherein the summarizer is further arranged to:
decompress the memory stream;
extract the document information form the memory stream; and
iterate the memory stream.

18. A computer-readable medium having stored thereon a data structure, the data structure comprising:
a first field containing data representing the contents of a document;
a second field containing data representing alternate forms of words in the document; and
a third field containing data representing word offsets of the document, wherein the third field includes an alternate bit that associates the word with an alternate form of the word in the second field when the alternate bit is set.

19. The computer-readable medium of claim 18, further comprising a fourth field containing data representing sentence offsets of the document.

20. The computer-readable medium of claim 18, further comprising a fifth field containing data representing the title of the document.
